(19) United States
(12) Patent Application Publication
(10) Pub. No.: US 2006/0286239 A1
(43) Pub. Date: Dec. 21, 2006

(54) Nanoscale materials

(75) Inventors: Firooz Rasouli, Midlothian, VA (US); Weijun Zhang, Richmond, VA (US)

Correspondence Address: BUCHANAN, INGERSOLL & ROONEY PC, POST OFFICE BOX 1404, ALEXANDRIA, VA, 22313-1404, US

(73) Assignee: Philip Morris USA Inc.

(21) Appl. No.: 11/435,826

(22) Filed: May 18, 2006

Related U.S. Application Data
(60) Provisional application No. 60/682,854, filed on May 20, 2005.

(51) Int. Cl. A23L 1/22

(52) U.S. Cl. 426/534

(57) ABSTRACT

Improved taste modifiers including nanoscale particles are disclosed. Preferred taste modifiers are inorganic or organic compounds having an average particle size of less than about 500 nm. Nanoscale particles of sodium chloride, for example, which can be stoichiometric or non-stoichiometric particles, can be used to enhance the flavor of foods and beverages as well as in other applications such as in ionic contrast media. Other applications for nanoscale particles include use in saline solutions for contact lenses, sterile solutions, intravenous (IV) solutions, or solutions for use by patients suffering from hypertension or diabetes. The nanoscale particles can be free-standing (unsupported) or supported on support particles such as particles of sodium chloride or particles of calcium carbonate.

### CROSS-REFERENCE TO RELATED APPLICATION

This application claims priority under 35 U.S.C. §119 to U.S. Provisional Application No. 60/682,854 entitled NANOSCALE MATERIALS, filed May 20, 2005, the entire content of which is hereby incorporated by reference.

### BACKGROUND

Taste modifiers are used to flavor foods and beverages. In particular, taste modifiers such as table salt (i.e., sodium chloride) can be added to foods and beverages to enhance taste. However, there are diseases of the human body that are exacerbated by the intake of sodium and in such instances it is preferred that the consumption of sodium be reduced or regulated. Hypertension and diabetes, for example, are diseases where the regulation of sodium chloride or sugar intake is desired. Individuals who must regulate their salt intake are presented with the problem of flavoring their foods so as to make them palatable while minimizing their sodium intake.

One approach for regulating the intake of sodium is to substitute potassium chloride or other salts for ordinary table salt. Unfortunately, potassium chloride is less than adequate as a taste modifier because its taste is generally perceived as different from that of table salt. Most other table salt substitutes are also regarded as inferior to table salt, and many, including potassium chloride, can leave an undesirable bitter aftertaste.

A further approach to regulating sodium chloride intake is to reduce the total sodium intake to an amount that can be tolerated without injury to an individual's health. It is generally understood that the related problems of regulating (i.e., minimizing) sodium intake and achieving food palatability would be addressed if the taste obtained using lower levels of sodium chloride could be enhanced or potentiated. In view of the developments to date, a taste modifier that is low in sodium and which provides the flavor attributes of table salt is desirable.

### SUMMARY

According to one embodiment, a taste modifier comprises particles of a nanoscale taste modifying agent. The nanoscale taste modifying agent, which can comprise an organic and/or inorganic material, preferably has a particle size smaller than 500 nanometers (e.g., smaller than 20 nanometers). The taste modifying agent is preferably mono-sized. Preferred taste modifying agents are salts or sugars. The nanoscale taste modifying agent can be a non-stoichiometric compound. The nanoscale taste modifying agent can have a substantially spherical morphology.

According to another embodiment, the taste modifying agent is incorporated in and/or on a substrate material and the taste modifying agent can comprise a stoichiometric or a non-stoichiometric compound. By way of example, the taste modifying agent can comprise sodium chloride having defects in the crystal structure thereof so as to provide a sub-stoichiometric amount of sodium. A method of enhancing sensorial impact comprises applying a nanoscale taste modifying agent to an object such as food.

In another embodiment, a method of making a taste modifying agent comprises subjecting a target such as sodium chloride or sugar to laser ablation in a chamber and condensing vaporized target material on a cooled surface in the chamber. Other methods of making a taste modifying material comprise flame spray pyrolysis, electro-spraying, evaporation/condensation, sputtering, or sol-gel processes.

According to another embodiment, a solution is disclosed. The solution can comprise nanoscale salt particles. The solution can be used for contact lenses, a sterile solution, contrast media for angiograms or computed tomography (“CT”) scans, patients suffering from hypertension or diabetes and/or an intravenous (“IV”) solution. The nanoscale salt particles can have a substantially spherical morphology. The nanoscale salt particles comprise non-stoichiometric sodium chloride particles.

In another embodiment, a method of dissolving nanoscale salt particles in a solvent is disclosed. The method comprises (a) adding nanoscale salt particles to a solvent; and (b) dissolving in the solvent a substantial amount of the nanoscale salt particles added in (a). The solvent is water and/or an organic solvent. The nanoscale salt particles comprise non-stoichiometric sodium chloride particles. The nanoscale salt particles can have a substantially spherical morphology.

### BRIEF DESCRIPTION OF THE DRAWINGS

FIG. 1 shows a schematic of the crystal structure of sodium chloride.

FIG. 2 shows a schematic of the mechanism for sodium ion recognition in taste receptor cells.

FIG. 3 shows a TEM image of nanoscale sodium chloride prepared by laser vaporization/condensation method.

### DETAILED DESCRIPTION

Disclosed herein are products and methods that relate to sensory materials such as inorganic (e.g., table salt) and organic (e.g., sugar) taste modifiers. The taste modifiers comprise nanoscale particles (i.e., nanoscale taste modifiers) such as nanoscale sodium chloride particles or nanoscale sugar particles. Preferred taste modifiers consist essentially of nanoscale particles. Further products and methods relate to nanoscale salts that can be used in ionic contrast media for CT scans and angiograms, as well as in other applications.

As defined herein, “nanoscale” particles have one or more critical dimensions (e.g., length, width, thickness, diameter, etc.) that are less than about 500 nm, more preferably less than about 100 nm. Preferred nanoscale particles have an average particle size of less than about 100 nm (e.g., less than about 20 nm). Preferred nanoscale sensory materials have a substantially uniform particle size distribution.

Because of their small size, the physical and/or chemical properties of nanoscale particles may differ from the properties of larger particles having the same composition. Moreover, the properties of solutions comprising nanoscale particles may differ from the properties of solutions comprising larger particles. Properties that can influence the taste and other sensory attributes of a particulate material include particle size, surface area (particularly the high surface area to volume ratio), solubility, pore structure, pH of a solution comprising the material, chemical potential, and, in the case of ionic nanoscale materials, the rate of dissociation of the ionic crystal. For example, the freezing point depression constant and osmotic pressure of a solution made using nanoscale particles (e.g., nanoscale solute) can be different than if the solution was made using larger particles.

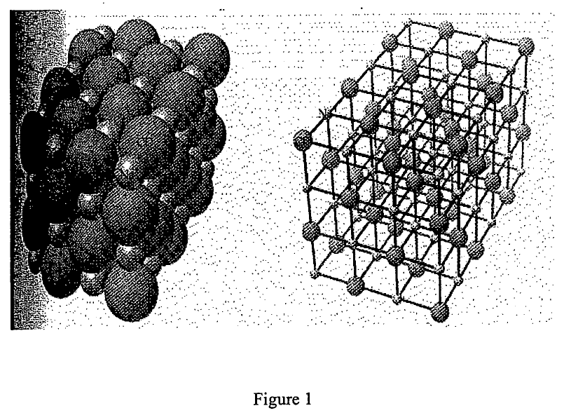

The nanoscale sensory materials can comprise inorganic sensory materials. Exemplary inorganic sensory materials comprise salts such as halide salts (e.g., chlorides, bromides, or iodides) of sodium, potassium, calcium, magnesium, and the like, as well as mixtures thereof. A nanoscale sensory material can comprise a mixture of two or more salts having different compositions. For example, one nanoscale sensory material can comprise a mixture of nanoscale sodium chloride particles and nanoscale potassium chloride particles. In an alternative embodiment, the nanoscale sensory material can comprise two or more cations that are incorporated in nanoscale particles having a substantially uniform composition. For example, a nanoscale sensory material can comprise sodium cations and potassium cations in a chloride salt. A preferred nanoscale salt comprises sodium chloride, which is a face centered cubic crystal (FIG. 1). Inorganic taste modifiers comprising nanoscale salt particles are preferably completely soluble in water, free flowing, essentially non-hygroscopic, and dissolve in aqueous solvents to form a substantially neutral aqueous solution (e.g., an aqueous solution having a pH of from about 6 to 8).

The nanoscale sensory materials can comprise organic sensory materials. Exemplary organic sensory materials include herbs and spices such as allspice, anise, basil, black pepper, caraway seed, cardamom, celery seed, chervil, cilantro, cinnamon, cloves, coriander, cumin, dill, fennel, ginger root, mace, marjoram, mint, mustard, nutmeg, oregano, paprika, parsley, poppy seed, red pepper, rosemary, saffron, sage, savory, sesame seed, tarragon, thyme, turmeric, vanilla bean, white pepper, and the like.

According to a first embodiment, nanoscale salts such as sodium chloride can provide a taste that is saltier than the same amount of salt comprising larger particles. Thus, a reduced amount of nanoscale sodium chloride as compared to regular salt can be used to achieve a given salty taste.

Taste is a response to chemical stimulation that enables an organism to detect flavors. In most vertebrate animals including humans, taste is produced by the stimulation by various substances of the taste buds, which are located in the mucous membrane of the tongue. A single taste bud comprises up to about two dozen taste receptor cells. A tiny hair projects from each cell to the surface of the tongue through a tiny pore. The receptor cells contain the endings of nerve filaments that can convey impulses to the taste center in the brain.

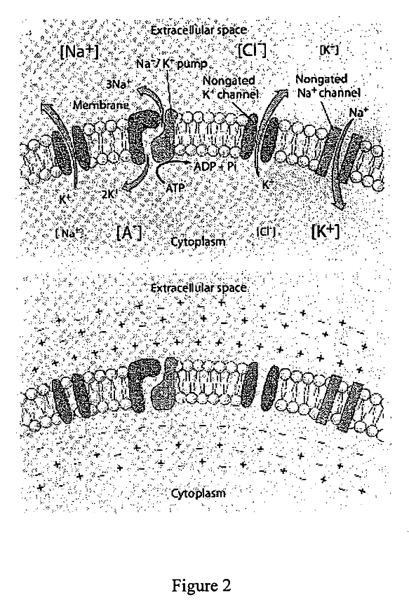

Ion channels form small openings through the surface membrane of the taste receptor cells that allow ions to pass either into or out of the cell (M. S. Gazzaniga, R. B. Ivry & G. R. Mangun, “Cognitive Neuroscience: The Biology of the Mind”, New York, Norton (1998)). Sodium ions (Na⁺) that come in contact with the tongue can enter the receptor cells via sodium ion channels (FIG. 2). These channels are amiloride-sensitive Na⁺ channels (as distinguished from tetrodotoxin (TTX)-sensitive Na⁺ channels found in nerves and muscles). The entry of a Na⁺ ion into a receptor cell causes a depolarization effect that creates a sensory stimulus. The taste receptor cells can convert energy associated with the sensory stimulus into electrical signals that can be sent to the brain and which carry information about the stimulus.

Without wishing to be bound by theory, the rate of dissociation and/or the solubility in a liquid of nanoscale salt particles can be different than conventional particles (e.g., salt particles having a larger particle size). As a result, for a given mass of solute, the concentration at a given time of dissociated ions (e.g., cations such as sodium cations) that are formed by mixing the solute particles with a liquid can be different for a solution made using nanoscale particles. This can affect the perceived taste, and a solution formed using nanoscale salt particles can have a different perceived taste than a solution made using larger (non-nanoscale) particles.

Because the osmotic pressure of a solution can vary as a function of the particle size of the solute, the interaction of the solution with natural or synthetic membranes can vary, as in the case of sensory organs such as taste receptors or kidney dialysis machines.

According to a second embodiment, nanoscale sodium chloride can be used in place of regular salt in ionic contrast media. For example, specially-designed nanoscale sodium chloride (e.g., nanoscale sodium chloride having a substoichiometric amount of chlorine) can be less corrosive than regular sodium chloride and therefore less harmful to tissue cells. The specially-designed nanoscale sodium chloride can be less harmful to tissue cells when compared with regular sodium chloride because of the presence of a sub-stoichiometric amount of chlorine, which is corrosive to tissue cells, in the specially-designed nanoscale sodium chloride.

Other applications for nanoscale sodium chloride include, but are not limited to, use in saline solutions for contact lenses, sterile solutions, intravenous (IV) solutions, as a solution for use by patients suffering from hypertension, etc.

The nanoscale taste modifiers can consist essentially of nanoscale particles of an inorganic or organic taste modifiers, or the nanoscale taste modifiers can be combined with other substances. For example, the nanoscale taste modifiers can be put on substrate materials such as active or inactive micelles or support particles. Particles of a nanoscale-salt such as nanoscale sodium chloride can be supported by micron-sized or larger substrate particles. Exemplary support particles are particles of sodium chloride or particles of calcium carbonate. Advantageously, by supporting the nanoscale particles on support particles, agglomeration of the nanoscale particles with each other can be minimized.

In a further embodiment, crystalline nanoscale particles (e.g., nanoscale salt particles) can be generated with defects. Preferably, crystal defects are manifested as a crystalline composition that is non-stoichiometric (e.g., the atomic ratio of Na⁺ to Cl⁻ in sodium chloride is greater than or less than unity). The defects can comprise vacancies, interstitials and/or substitutions by homovalent or heterovalent ions.

A preferred nanoscale crystal comprises sodium chloride. Non-stoichiometric nanoscale sodium chloride can comprise sodium vacancies (V_{Na}). Further, a solute element (S) such as magnesium, potassium and/or calcium can be substituted within the sodium chloride crystal at a sodium site (S_{Na}) and/or the solute element can be incorporated into the crystal at an interstitial site (S_{I}). Because salty taste is triggered by depolarization resulting from the diffusion of sodium ions into a receptor cell, a change in the initial ratio of Na⁺ and Cl⁻ can have an effect on the perceived taste.

Additives such as magnesium can be added to sodium chloride as a free flow enhancer and iodine compounds can be added as essential minerals for the body.

Nanoscale sodium chloride can be manufactured using laser ablation. In this method, a pelletized sodium chloride sample is used as the target in a laser ablation chamber. Crystalline and/or amorphous salt nanoscale particles created by ablation of the target are condensed on, and can be collected from, a cold surface of the chamber.

The formation of nanoscale particles using laser ablation is disclosed in commonly-owned U.S. patent application Ser. No. 10/972,209 filed on Oct. 25, 2004 published on Feb. 16, 2006 as U.S. Pre-Grant Publication Number 2006/0032510, the contents of which are incorporated herein by reference. Inorganic or organic nanoscale modifiers can be manufactured via laser ablation or other suitable techniques such as sputtering, flame spray pyrolysis, electro-spraying, evaporation/condensation, sol-gel and other deposition routes. In general, in addition to inorganic salts, the concept can be applied to other spices and seasonings.

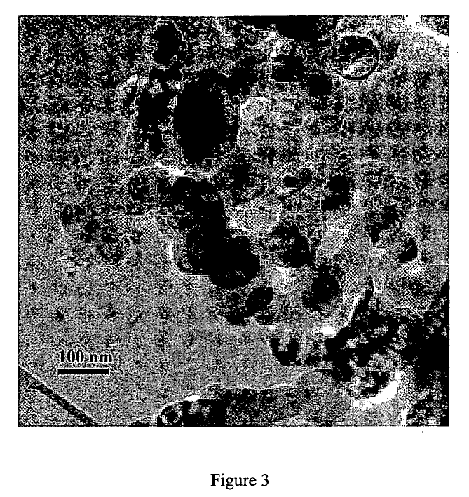

Sodium chloride nanoscale particles were generated by using the laser ablation method. A pelletized and substantially pure sodium chloride sample was used as the target in the laser ablation chamber to generate the nanoscale sodium chloride particles. The plasma created by the ablation was condensed on the cold surface of the chamber generating nanoscale sodium chloride particles. A Transition Electron Microscopy (“TEM”) image of the nanoscale sodium chloride particles obtained above is shown in FIG. 3. The size of these nanoscale sodium chloride particles is in the range of from about 20 to about 100 nanometers as measured from the TEM image shown in FIG. 3. Generally, particles less than 100 nm are considered nano-particles.

Further, upon analyzing the nanoscale sodium chloride particles shown in FIG. 3, it was concluded that the nanoscale sodium chloride particles have a substantially spherical morphology. These nanoscale sodium chloride particles with a substantially spherical morphology are different from conventional bulk sodium chloride particles that commonly have a cubical morphology.

Due to the substantially spherical morphology of the nanoscale sodium chloride particles, the atoms on the spherical particle surface have a lower coordination number compared to the atoms in a flat crystal surface (i.e., conventional cubical morphology of sodium chloride particles). The nanoscale sodium chloride particles having a substantially spherical morphology are therefore at relatively high energy states compared to the atoms on the equivalent flat surface of conventional sodium chloride particles having a cubical morphology. As the atoms in the nanoscale sodium chloride particles having a substantially spherical morphology are at higher energy states, the release of these atoms from the spherical particles requires a relatively low activation energy compared to the atoms in sodium chloride particles having a cubical morphology.

Without wishing to be bound by theory, the low activation energy requirement in conjunction with the high surface area of the nanoscale sodium chloride particles can enhance the solubility rate of the nanoscale sodium chloride particles.

Further, nanoscale taste modifiers, such as nanoscale sodium chloride particles, can be substantially soluble in solvents, such as organic solvents, that commonly do not readily dissolve bulk particles of the same taste modifiers, such as bulk sodium chloride particles. The organic solvents include but are not limited to alcohol. The solvent can include saliva.

A composition analysis of the nanoscale sodium chloride particles (shown in FIG. 3) by an Energy Dispersive Spectrometer (“EDS”) indicates that the nanoscale sodium chloride particles are chlorine deficient, i.e., the non-stoichiometric ratio of chlorine to sodium is less than one or the non-stoichiometric ratio of sodium to chlorine is greater than one.

In another embodiment, chlorine rich nanoscale sodium chloride particles can be prepared by changing the composition of the material used as the target during the evaporation/condensation process. For example, by using a mixture of bulk sodium chloride particles with another chlorine rich compound as the target, the evaporation/condensation (e.g., laser ablation) of such a target will lead to chlorine rich nanoscale particles, wherein the ratio of chlorine to sodium is greater than one.

In another embodiment, the conditions during the evaporation/condensation process can be tuned (e.g., partial pressure of relevant gas inside the chamber can be tuned) to obtain chlorine rich nanoscale sodium chloride particles.

Due to chlorine deficiency in the nanoscale sodium chloride particles, the particles have vacancies that facilitate incorporation of other taste modifier elements such as iodine, boron, etc., to the sodium chloride particles.

Furthermore, the addition of taste modifier elements into the crystal structure of sodium chloride can be directly achieved by ball milling (or other similar process) of a coarse powder or coarse powder mixtures (i.e., sodium chloride, magnesium chloride, iodides, etc.). Due to the high energy generated by ball milling, the size of the coarse powders can be reduced to less than about one micron, and the solubility of the taste modifier compounds in sodium chloride can be increased.

All of the above-mentioned references are herein incorporated by reference in their entirety to the same extent as if each individual reference was specifically and individually indicated to be incorporated herein by reference in its entirety.

While the invention has been described with reference to preferred embodiments, it is to be understood that variations and modifications may be resorted to as will be apparent to those skilled in the art. Such variations and modifications are to be considered within the purview and scope of the invention as defined by the claims appended hereto.

What is claimed is:

1. A taste modifier comprising particles of a nanoscale taste modifying agent.

2. The taste modifier according to claim 1, wherein the taste modifying agent has a particle size smaller than 500 nanometers.

3. The taste modifier according to claim 1, wherein the taste modifying agent has a particle size smaller than 20 nanometers.

4. The taste modifier according to claim 1, wherein (a) the particle size distribution of the taste modifying agent is substantially uniform, (b) the taste modifying agent is an organic and/or inorganic material, (c) the taste modifying agent is a salt, and/or (d) the taste modifying agent is sugar.

5. The taste modifier according to claim 1, wherein (a) the taste modifying agent is incorporated in and/or on a substrate material, (b) the taste modifying agent comprises a non-stoichiometric compound, and/or (c) the taste modifying agent comprises sodium chloride with defects in the crystal structure thereof so as to provide a sub-stoichiometric amount of sodium.

6. The taste modifier according to claim 1, wherein the taste modifying agent is supported on support particles.

7. The taste modifier according to claim 6, wherein the support particles comprise particles of sodium chloride or particles of calcium carbonate.

8. A method of making the taste modifier according to claim 1, comprising (a) subjecting sodium chloride to laser ablation in a chamber and condensing vaporized sodium chloride on a cooled surface in the chamber, (b) subjecting sugar to evaporation in a chamber and condensing vaporized sugar on a cooled surface in the chamber, and/or (c) incorporating the taste modifying material in and/or on a substrate material.

9. A method of making the taste modifier according to claim 1, comprising subjecting an organic or inorganic taste modifying material to a flame spray pyrolysis, electro-spraying, evaporation/condensation, sputtering, sol-gel process, or ball milling.

10. The taste modifier according to claim 1, wherein the taste modifying agent comprises a spice.

11. The taste modifier according to claim 1, wherein the taste modifying agent comprises sodium chloride particles having a substantially spherical morphology.

12. The taste modifier according to claim 1, wherein the taste modifying agent is substantially dissolved in a solvent.

13. The taste modifier according to claim 12, wherein the solvent is (i) water, (ii) an organic solvent, and/or (iii) saliva.

14. A method of enhancing sensorial impact by applying a nanoscale taste modifying agent to an object.

15. The method according to claim 14, wherein: (a) the object is food, (b) the taste modifying agent is an organic or inorganic material, (c) the taste modifying agent is salt or sugar, (d) the taste modifying agent is a non-stoichiometric compound, and/or (e) the taste modifying agent comprises sodium chloride particles having a spherical morphology.

16. A solution comprising nanoscale salt particles,
wherein the nanoscale salt particles comprise non-stoichiometric nanoscale salt particles, and
wherein the solution is (a) a saline solution for use with contact lenses, (b) a sterile solution, (c) an intravenous (IV) solution, (d) contrast media for angiograms or CT scans, or (e) a solution for use by patients suffering from hypertension or diabetes.

17. The solution of claim 16, wherein (a) the non-stoichiometric nanoscale salt particles comprise sodium chloride particles having a substantially spherical morphology, and/or (b) the nanoscale salt particles are substantially dissolved in the solution.

18. A method of dissolving nanoscale salt particles in a solvent comprising:
(a) adding nanoscale salt particles to a solvent; and
(b) dissolving in the solvent a substantial amount of the nanoscale salt particles added in (a).

19. The method of claim 18, wherein the solvent is (i) water, (ii) an organic solvent, and/or (iii) saliva.

20. The method of claim 18, wherein the nanoscale salt particles comprise non-stoichiometric sodium chloride particles.
